(19) United States
(12) Patent Application Publication
(10) Pub. No.: US 2019/0366373 A1
(43) Pub. Date: Dec. 5, 2019

(54) PATTERNED SPRINKLER HEADS AND METHOD FOR IMPROVING SPRINKLER SYSTEMS

(71) Applicant: Christian Bizer, Spotswood, NJ (US)

(72) Inventor: Christian Bizer, Spotswood, NJ (US)

(21) Appl. No.: 15/991,303

(22) Filed: May 29, 2018

(51) Int. Cl. B05B 12/08; B05B 1/18

(52) U.S. Cl. CPC B05B 12/082; B05B 1/046; B05B 1/185; B05B 12/087

(57) ABSTRACT

A method for improving sprinkler systems is provided. The method embodies sprinkler heads adapted to emit specific shaped spray patterns conducive for efficiently distributing water to surface area having a matching shape. The sprinkler heads may be rectangular, triangular or any shape as long as they function to emit sprayed fluids that conforms to a predetermined shape. That predetermined shape may be defined by the body of the sprinkler head itself. Specifically, the nozzle openings through which the fluid is emitted are oriented in an arrangement of the predetermined shape. The arrangement may be disposed along a beveled surface of the sprinkler head body.

### BACKGROUND OF THE INVENTION

The present invention relates to sprinkler systems and, more particularly, to a sprinkler system embodying a method of utilizing multiple-sided sprinkler heads dimensioned and adapted to emit a predetermined shape of fluid spray cooperating with a specific shape of surface area, thereby improving the efficiency of pre-existing or proposed sprinkler systems.

The efficient distribution of sprayed fluid over a surface area calls for the sprinkler heads to be patterned. Current sprinkler heads are in one pattern, round (or circular). In other words, current sprinkler heads may vary in the rate that water is emitted or in the form of the emission—some have a single stream that jets out in one direction as the head rotates, while others are stationary as water is distributed through a plurality of spray openings like a fountain—but the current sprinkler heads provide the plurality of spray openings oriented in a circular arrangement.

Such circularly-arranged sprinkler heads must be located along a non-circular surface area for coverage thereto, for example when watering a lawn, and so the circular arrangement result in a spray distribution that is suboptimal. FIG. 4 shows four (4) such circularly-arranged sprinkler heads used to cover a predetermined rectangular surface area, whereby areas of overlap are created, resulting in areas of wasteful or inefficient water distribution.

FIG. 5 illustrates the same surface area, covered by a single squarely-arranged and patterned sprinkler head, demonstrating the efficiency thereof. This efficiency translates to a cost-reduction in terms of the number of sprinkler heads needed and the amount of water used in this non-overlapping scenario. The efficiency may also translate to reduced digging costs when installing new sprinkler systems, since the increased efficiency in water distribution minimizes the amount of output sources (from the supply line) required by an underground sprinkler system, which in turn requires less digging for less supply lines-output sources.

The advantages of the present invention are relevant because surface areas receiving watering distributed through sprinkler heads, such as lawns and landscapes, are typically not round or circular in shape. Real estate and properties are sold in lots typically consisting of squares, rectangles, triangles and parallelograms, who's shape is chosen to efficiently divide a large parcel of land down to smaller lots. As a result, a majority of the basic lot shapes are rectangular, and accordingly circularly-arranged water distribution just does not work efficiently.

As can be seen, there is a need for a sprinkler system and water distribution method embodying multiple-sided shaped sprinkler heads, wherein such heads are configured to deliver the water in various non-circular shaped patterns. Such “patterned sprinkler heads” enable benefits and improvements when installed to existing irrigation and sprinkler systems. The first benefit is efficiency: the surface area to be watered will be covered more effectively. The second benefit is cost reduction: the new design of sprinkler heads effectively cut down the amount of water needed to be used in present irrigation systems. The third benefit is reduced digging: with current irrigation systems, the installation process can be daunting and extensive as irrigation lines must be dug into the ground to supply the water to the sprinkler heads. During this process the landscape can be ripped apart, typically inviting anxiety by home and business owners. The present invention embodies a design that keeps water line digging down to a minimum.

### SUMMARY OF THE INVENTION

In one aspect of the present invention, a sprinkler head includes a body defined in part by an upper surface and a spaced apart lower surface; a beveled edge extending between peripheries of each of the upper and lower surfaces; and a plurality of nozzles housed in the body and adapted to be fluidly coupled to a fluid outlet, each nozzle having a nozzle opening terminating at the beveled edge, the plurality of nozzle openings spaced apart and arranged in a multi-sided shape along the beveled edge.

In another aspect of the present invention, the sprinkler head includes a body defined in part by an upper surface and a spaced apart lower surface; a beveled edge extending between peripheries of each of the upper and lower surfaces; and a plurality of nozzles housed in the body and adapted to be fluidly coupled to a fluid outlet, each nozzle having a nozzle opening terminating at the beveled edge, the plurality of nozzle openings spaced apart and arranged along the beveled edge in a rectangular or triangular shape, wherein the beveled edge is oriented at an angle of incidence relative to a plane normal to the fluid outlet, and wherein the angle of incidence ranges between 30 and 60 degrees.

In yet another aspect of the present invention, a method for improving an application of a fluid from a sprinkler system associated with a surface area having a predetermined shape includes providing at least one above-mentioned sprinkler head, wherein the multi-sided shape generally matches the predetermined shape; and fluidly connecting each said sprinkler head to an outlet of the sprinkler system.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is a section view of an exemplary embodiment of the present invention, taken along line 3-3 of FIG. 2;

FIG. 4 is a schematic view illustrating the overlapping and over-spraying of prior art sprinkler head spray patterns;

FIG. 5 is a schematic view of an exemplary embodiment of the present invention illustrating the efficient resultant spraying pattern;

FIG. 6 is a perspective view of an exemplary embodiment of the present invention; and

FIG. 7 is a top plan view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for improving sprinkler systems that embodies sprinkler heads adapted to emit specific shaped spray patterns conducive for efficiently distributing water to surface area having a matching shape. The sprinkler heads may be rectangular, triangular or any shape as long as they function to emit sprayed fluid patterns that conforms to a predetermined shape. That predetermined shape may be defined by the body of the sprinkler head itself. Specifically, the nozzle openings through which the fluid is emitted are oriented in an arrangement of the predetermined shape. The arrangement may be disposed along a beveled surface of the sprinkler head body.

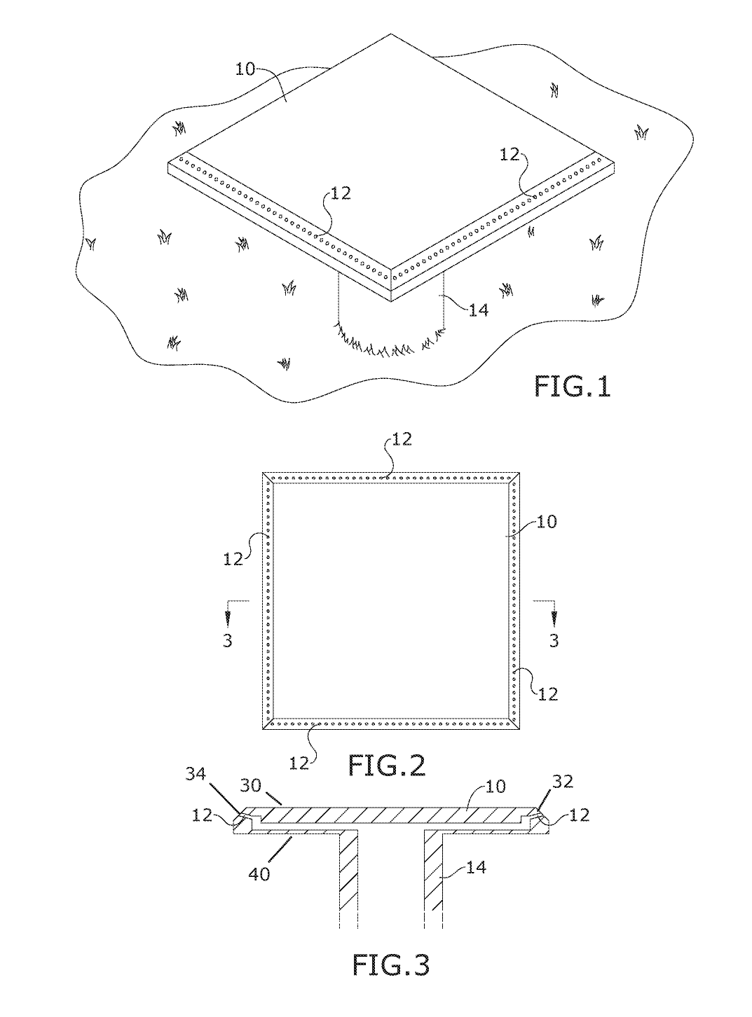

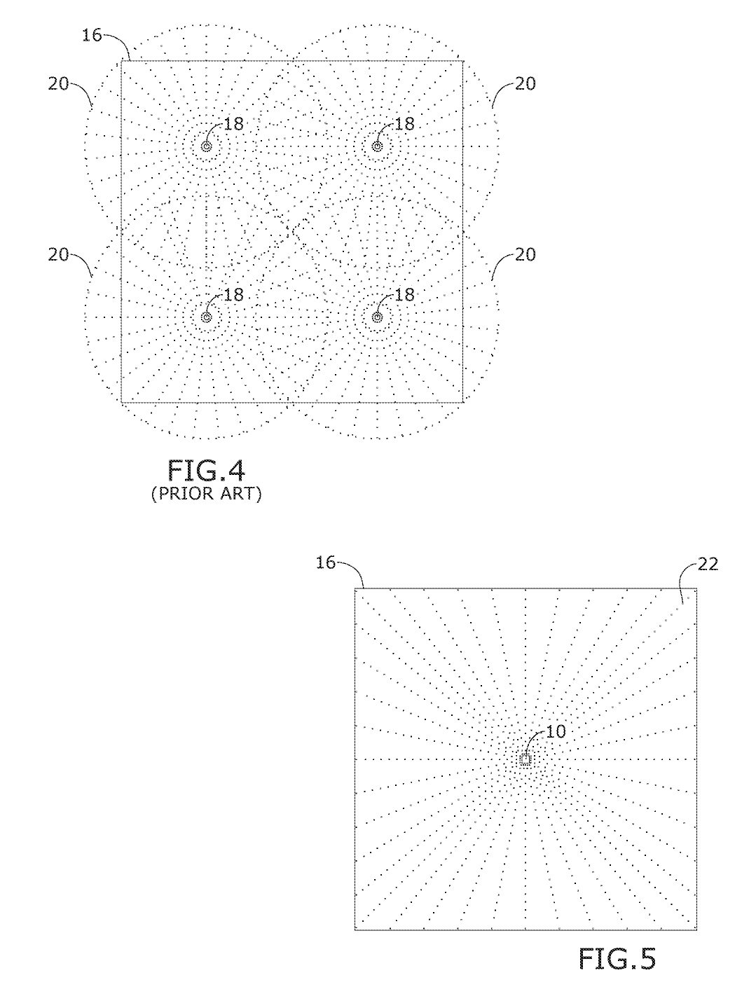

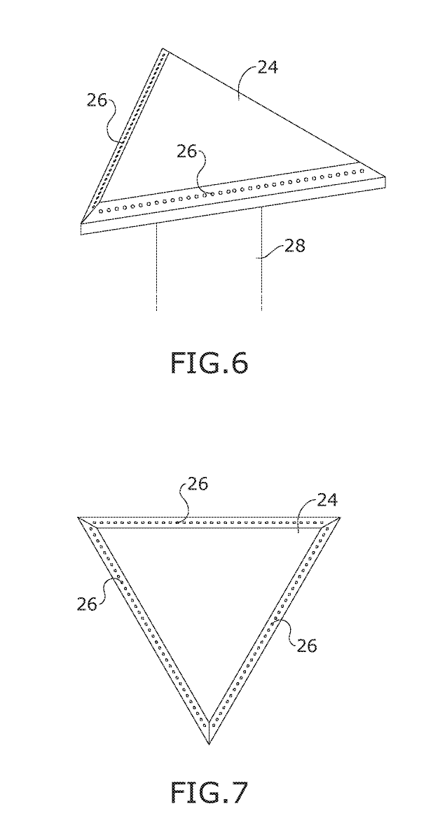

Referring to FIGS. 1 through 7, the present invention may include a shaped sprinkler head 10 or 24 configured to deliver water to a specific shape of surface area 16. The sprinkler head 10 may be square, the sprinkler head 24 may be triangular, the sprinkler head embodied in the present invention may be configured in any shape, so long as the sprinkler heads function in accordance with the present invention as described herein. Each sprinkler head 10 or 24 provides a body having an upper surface 30 and a lower surface 40. Extending between a periphery of each of the upper and lower surfaces 30 and 40 may be a beveled edge 32. An angle of incidence for the beveled edge 32 may be approximately 45 degrees relative to the generally coplanar upper and lower surfaces 30 and 40. In some embodiments, the angle of incidence may range from 30 to 60 degrees relative to the generally coplanar upper and lower surfaces 30 and 40. Along the beveled edge 32 are spaced apart distal openings 34 of spray nozzles 12 and 26, each spray nozzle 12 or 26 fluidly connected to a spray outlet 14 or 28, in turn communicable to pressurized fluid, such as a sprinkler system.

Thus, the shape of the beveled edge 32 and as a result the arrangement of nozzle openings 34 may be rectangular, triangular or any shape as mentioned above, whereby fluid under pressure is emitted from the plurality of nozzle openings 34 in conformity to the respective shape of said arrangement and possibly the beveled edge 32.

As illustrated in FIG. 5, the resulting spray of emitted fluid conforms to the said respective shape 22, optimal for surface area 16 of a similar shape. The greater the fluid pressure, the larger the resulting dimensioned shape of spray 22, while the less the fluid pressure through the outlet 14 or 28, the dimensionally smaller the resulting shape of spray 22. Contrast this with the present circular shape of spray 20 along a rectangular surface area 16, as illustrated in FIG. 4, and the inefficiencies and wasteful overlaps of multiple circular spray heads 18 are apparent.

Each sprinkler head 10 or 24 may provide an interface (not shown), such as a brass head, that is threaded or otherwise engageable to fluidly connect to the outlets 14 or 28 of the sprinkler system's supply lines (not shown).

A method of using the present invention may include the following. The sprinkler heads 10 and/or 24 disclosed above may be provided. A user may operatively associate one or more sprinkler head 10 or 24 to an outlet 14 or 28 selectively to conform to the surface area 16 they desire to distribute water to through a predetermined shape fluid spray defined by the arrangement of nozzle openings 34 arrangement along the beveled edge 32 of each respective sprinkler head 10 or 24. The outward facing portion of the lower surface 40 typically is parallel to the surface area (or perpendicular to the outlet 14 or 28) and thereby defines a plane that the bevel edge 32 and its incidental angle is relative to. Then the user may selectively regulate the flow of fluid through the connected outlet(s) 14 and/or 28 to define the dimensions of the resulting spray pattern 22. It being understood that if the rectangular surface area 16 is large, the user may use two triangular sprinkler heads 24 to provide optimal coverage as a rectangle is bisected into two triangles.

It should be understood, of course, that the foregoing relates to exemplary embodiments of the invention and that modifications may be made without departing from the spirit and scope of the invention as set forth in the following claims.

What is claimed is:

1. A sprinkler head, comprising:
a body defined in part by an upper surface and a spaced apart lower surface;
a beveled edge extending between peripheries of each of the upper and lower surfaces; and
a plurality of nozzles housed in the body and adapted to be fluidly coupled to a fluid outlet, each nozzle having a nozzle opening terminating at the beveled edge, the plurality of nozzle openings spaced apart and arranged in a multi-sided shape along the beveled edge.

2. The sprinkler head of claim 1, wherein the multi-sided shape is a rectangle.

3. The sprinkler head of claim 1, wherein the multi-sided shape is a triangle.

4. The sprinkler head of claim 1, wherein the beveled edge is oriented at an angle of incidence relative to a plane normal to the fluid outlet.

5. The sprinkler head of claim 4, wherein the angle of incidence is approximately 45 degrees.

6. The sprinkler head of claim 4, wherein the angle of incidence ranges between 30 and 60 degrees.

7. A sprinkler head, comprising:
a body defined in part by an upper surface and a spaced apart lower surface;
a beveled edge extending between peripheries of each of the upper and lower surfaces; and
a plurality of nozzles housed in the body and adapted to be fluidly coupled to a fluid outlet, each nozzle having a nozzle opening terminating at the beveled edge, the plurality of nozzle openings spaced apart and arranged along the beveled edge in a rectangular or triangular shape,
wherein the beveled edge is oriented at an angle of incidence relative to a plane normal to the fluid outlet, and wherein the angle of incidence ranges between 30 and 60 degrees.

8. A method for improving an application of a fluid from a sprinkler system associated with a surface area having a predetermined shape, comprising the steps of:
providing at least one sprinkler head of claim 1, wherein the multi-sided shape generally matches the predetermined shape; and
fluidly connecting each said sprinkler head to an outlet of the sprinkler system.

9. The method of claim 1, further comprising the steps of selectively increasing a flow of the fluid through each respective outlet to adjust a resulting spray pattern through each plurality of nozzle openings.
